(19) United States
(12) Patent Application Publication
(10) Pub. No.: US 2010/0088361 A1
(43) Pub. Date: Apr. 8, 2010

(54) SYSTEM FOR PROVIDING SERVICES AND PRODUCTS USING HOME AUDIO VISUAL SYSTEM

(75) Inventor: John Oliver, Mansfield, TX (US)

Correspondence Address: HOWISON & ARNOTT, L.L.P, P.O. BOX 741715, DALLAS, TX, 75374-1715, US

(73) Assignee: ASPEN MEDIA PRODUCTS, LLC, Dallas, TX (US)

(21) Appl. No.: 12/246,059

(22) Filed: Oct. 6, 2008

(51) Int. Cl. G06F 15/16

(52) U.S. Cl. 709/203

(57) ABSTRACT

A system for providing products and services comprises a client module that enables a user to order the products and services over a connected network. The client module is implemented within in a home audio visual system. A server remotely located from the client module is interconnected with the client module via the connected network. Responsive to a user request for the products or services via the client module, the server determines a plurality of different vendors providing the products or services that are within a predetermined distance from a location of the client module and transmits data relating to the determined plurality of different vendors to the client over the connected network. Responsive to the received data, the client generates a graphical user interface displaying the plurality of different vendors through the home audio visual system.

### TECHNICAL FIELD

The present invention relates to the purchase of products and services over a network, and more particularly, to a system and method utilizing a home audio visual system to purchase the products and services from locally based vendors.

### BACKGROUND

Consumers are increasingly purchasing their products and services using online interaction through the internet. A user is able to search through their computer using various online search engines to find a variety of products and services from companies and individuals advertising on internet websites. A number of entities are available on the internet for providing any particular desired product or service. While any variety of product and service may be found via the internet, a user must often go to a great deal of time and effort in order to locate particular products or services. This is often done using well known search engines such as Google, etc.

One problem with such a method for locating online products and services is that the user must wade through a large amount of information in order to locate products or services that are located within the home area of the user. For example, if user's were seeking particular personalized services that required the vendor to come to their home or for the user to travel a short distance to the location of the vendor, the user is of course only interested in services and/or products that may be provided within a reasonable traveling distance of the user. This may often require the user to go through a great deal of manual filtering or searching for the necessary search terms in order to locate information on products and services that are closely located to the user's computer. This type of search process additionally requires the user to have a great deal of knowledge and sophistication with respect to the operation of home computers, and the ability to navigate and search for information via the internet. Thus, there has arisen a need for an improved product and service based system that provides a user a manner for easily finding locally based products and services.

### SUMMARY

The present invention, as disclosed and described herein, in one aspect thereof, comprises a system for providing products and services. The system comprises a client module enabling a user to order the products and services over a connected network, wherein the client module is implemented within a home audio visual system. The system further includes a server remotely located from the client module that is interconnected with the client module via the connected network. Responsive to a user request for a particular product or services via the client module, the server determines a plurality of different vendors providing the products or services that are within a predetermined distance from the location of the client module. The server transmits data relating to the determined plurality of vendors to the client module over the connected network. Responsive to the received data, the client module generates a graphical user interface displaying the plurality of different vendors through the home audio visual system.

### BRIEF DESCRIPTION OF THE DRAWINGS

For a more complete understanding, reference is now made to the following description taken in conjunction with the accompanying Drawings in which:

FIG. 1 is a block diagram of the operating environment of the system of the present disclosure;

FIG. 2 illustrates the various client side functional blocks of the system of the present disclosure;

FIG. 3 illustrates a graphical user interface of a registration form;

FIG. 4 illustrates the graphical user interface via which a user may access various products and services;

FIG. 5 is an illustration of a graphical user interface enabling the user to access restaurant services;

FIG. 6 illustrates a graphical user interface through which a user may access home services;

FIG. 7 illustrates a graphical user interface through which may access automobile services;

FIG. 8 illustrates a graphical user interface through which a user may access lawn services;

FIG. 9 is a flow diagram illustrating the operation of the system for ordering products and services according to the present disclosure;

FIG. 10 illustrates a graphical user interface enabling through which a user registers information with the system;

FIG. 11 illustrates how differing PINs may be used in the system;

FIG. 12 is a functional diagram illustrating the manner in which a user may locate particular services, in this case restaurant services, and obtain an order therefrom; and

FIG. 13 is a graphical user interface of a restaurant menu;

FIG. 14 is a flow diagram illustrating the process by which a user is presented with a group of vendors;

FIG. 15 is a flow diagram more fully illustrating the process by which the central office may order services on behalf of a user;

FIG. 16 is a flow diagram illustrating the process for ordering a product or service via the system.

### DETAILED DESCRIPTION

Referring now to the drawings, wherein like reference numbers are used herein to designate like elements throughout, the various views and embodiments of a system for providing services and products using a home audio visual system are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

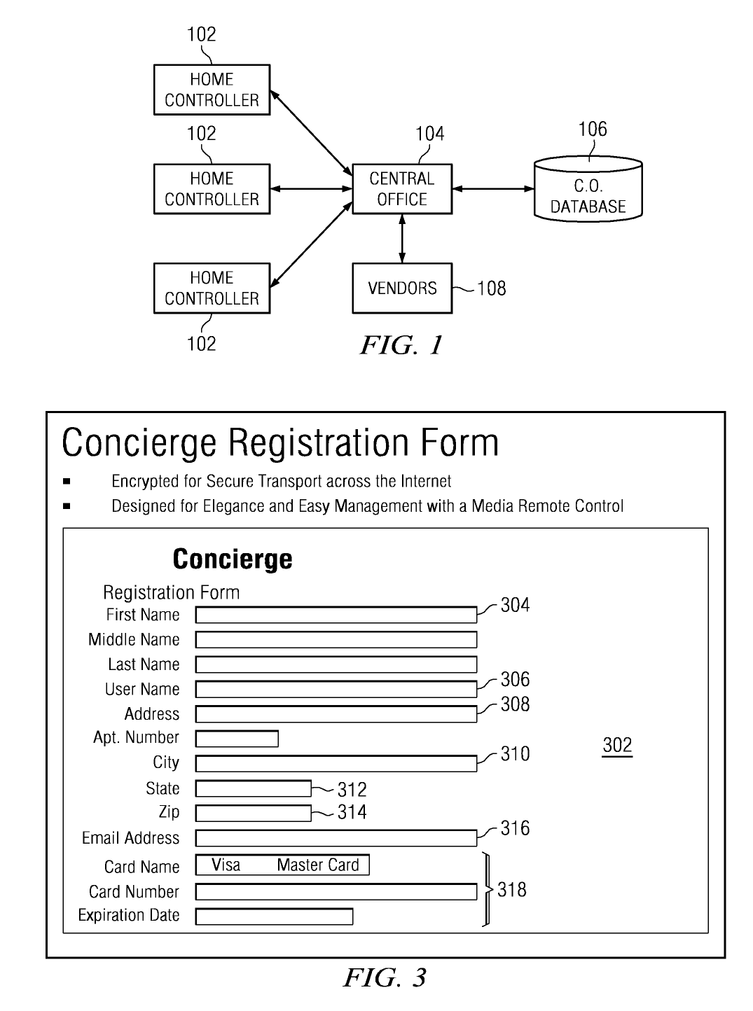

Referring now to FIG. 1, there is illustrated the operating environment of the system for providing local services and products through a home based audio visual system according to the present invention. The system includes a home controller 102 that will be located within a home of a particular user of the system. Each home controller 102 will be separately located within a separate home. The home controller 102 is associated with the audio visual system of a user within the home. Thus, the user may be able to access the functionalities of the system through the home controller 102 using a remote control device and viewing various options through a television screen that is in communication with the home audio visual network.

The home controller 102 is in communication with a central office 104 through, for example, the internet or some other type of telecommunications network. The central office 104 provides the necessary processing capabilities enabling the central office 104 to locate products and/or services requested by the home controller 102. The data necessary to enable the central office controller 104 to locate this information is contained within a central office database 106. The central office database 106 in addition to containing data necessary for a user at a home controller 102 to obtain product and service information, contains all of the information necessary for determining which particular home controller 102 is being communicated with and its location within an area.

The central office 104 also has the capability to communicate with a variety of vendors 108. The vendors 108 provide the products and/or services that may be requested by a user of the home controller 102 and are stored within the central office database 106 to enable the central office 104 to easily establish communications with the vendors 108 responsive to requests from the home controllers 102 and to provide the home controllers 102 various information relating to the vendors 108 from the central office 104.

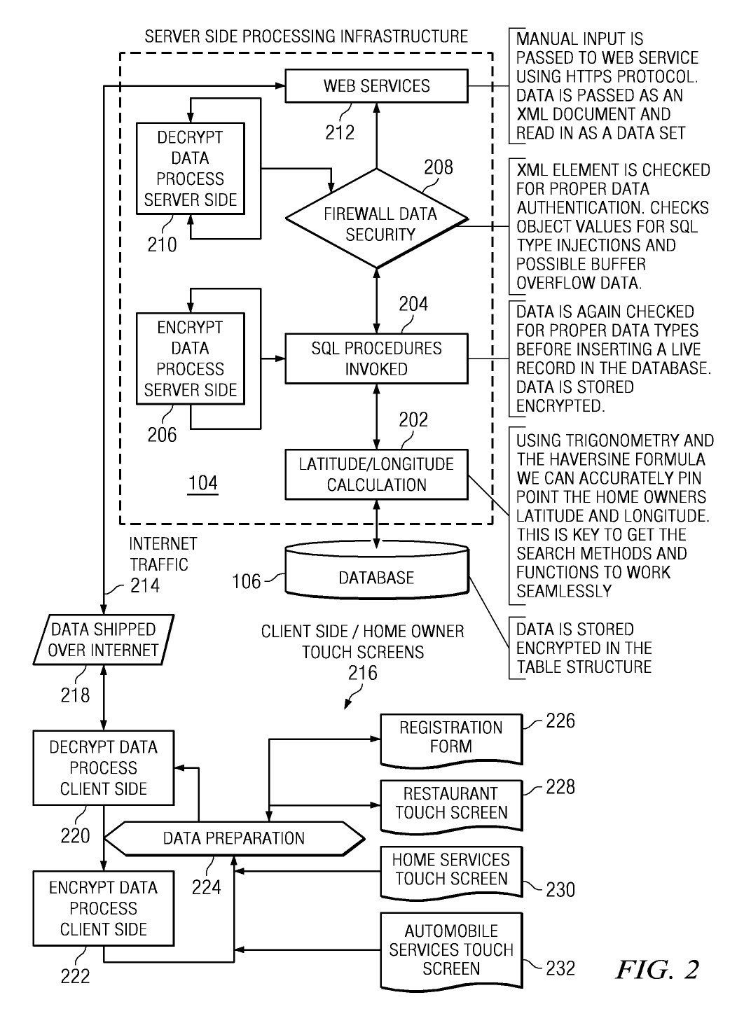

Referring now to FIG. 2, there are illustrated the various functionalities and infrastructures associated with the client side home owner screens 202 associating with the home controllers 102 and the central office 104 and central office database 106 on the server side. As previously mentioned, the central office database 106 stores information relating to various client-side home controllers 102 and potential vendors 108 from which a user may request products or services. The information relating to these entities are stored within the database 106 and encrypted in a table structure 106 contained within the database 106. The information from the database 106 may be used by the longitude/latitude calculation functionality 202 within the central office 104 to enable the central office 104 to calculate the position of a home controller 102 requesting particular services and the position of a vendor 108 from which services may be requested.

The latitude/longitude calculation functionality 202 uses trigonometry and the haversine formula to accurately pinpoint a homeowner's longitude and latitude and the longitude and the latitude of various associated vendors. This information enables the central office 104 to search for various vendors responsive to home controller 102 requests. The haversine formula is an equation for giving great circle distances between two points on a sphere from their longitudes and latitudes. For two points on a sphere of radius R with latitudes Φand Φ₂, latitude separation ΔΦ=Φ1-Φ2, and longitude separation ΔΛ, where angles are radians, the distance between the two points along a great circle is related to their location by the formula:

$$haversine ( \frac{d}{R} ) = haversine ( Δ Φ ) + cos ( {Φ}_{1} ) cos ( {Φ}_{2} ) haversine ( Δ Λ )$$

The longitude/latitude calculation function 202 may calculate the distances between the home controller 102 and any number of vendors 108 meeting a particular search criteria. For example, the user may ask information about all Mexican food restaurants within five miles of their home. The information relating to Mexican food restaurants would be stored within the database 106 and the location of these restaurants would also be stored within the database 106. The longitude/latitude calculation functionality 202 would calculate the distance between these restaurants stored within the database 106, and the location of the home controller 102 as indicated by the associated information with the home controller within the database 106.

The SQL procedures function 204 is responsible for checking transmitted or received data for proper SQL data types before inserting a live record within the database 106. The data that is stored within the database 106 is stored in an encrypted format that is controlled by the encryption data process 206. The encryption data process 206 will encrypt all data that has been received by the central office 104 before any information is stored within the database 106. The firewall data security process 208 is responsible for checking XML elements within received data for proper data authentication. The firewall data security process 208 checks object values for SQL type injections and possible buffer overflow data. Working with the firewall data security 208 is the decrypt data process 210. The decrypt data process 210 decrypts all encrypted data received over the communications interface of the control office 104 such that the central office 104 may read all received information.

The web service functionality 212 enables internet based communications between the central office controller 104 and the home controllers 102 and additionally enables communications between the central office controller 104 and any external vendors 108. Manual input and data is transmitted to and from the central office 104 through a web based service using the http protocol. Data is transmitted as an XML document and is read into the central office 104 as a data set. Internet traffic is transmitted between the central office 104 and the client side of the system within a home controller 102 over an internet communications link 214. While the present embodiment envisions the use of an internet communications link 214, other types of telecommunication or network links enabling communications between the central office 104 and the home controllers 102 and vendors 108 may also be utilized within the system of the present invention.

Implemented within the home controller 102 is a client side software functionality 216 that in one embodiment may be implemented to run within the Windows Media Center of Microsoft software. While the present description envisions the operation of the client side functionalities within the Windows Media Center, the client may operate within other software packages or may be implemented as a stand alone feature in some embodiments. The client side functionalities 216 include a data interface 218 enabling the transmission of and receipt of data over the internet. As described previously, the client side functionalities 216 could also utilize and interface 218 transmitting information over other types of telecommunications or data networks. The decryption functionalities 220 are responsible for decrypting data that has been received over the internet connection 214 by the client side functionalities 216. Likewise, the encryption functionalities 222 are responsible for encrypting data that is transmitted and received over the communications interface 218.

The data preparation functionalities 224 controls operation of the Custom Data Type that has properties for a specific data context that can be serialized and securely transferred over the Internet through web services. The data preparation functionalities 224 further includes the ability to serialize the object with exposed properties containing pieces of information for that specific object. In the context of data storage and transmission, serialization is the process of saving an object onto a storage medium (such as a file, or a memory buffer) or transmitting it across a network connection link in binary form. When the resulting series of bytes is reread according to the serialization format, it can be used to create an accurate clone of the original object. This process of serializing an object is also called deflating or marshalling an object. The opposite operation, extracting a data structure from a series of bytes, is deserialization (which is also called inflating or unmarshalling). The data preparation functionalities 224 receive inputs information from various graphical user interface screens that enables a user to input various pieces of information into the client side functionalities 216 through a touch screen associated with their home audio visual system or associated with a displayed screen on their television controlled via a remote control through their audio visual system at home.

Referring now also to FIGS. 3-8 in conjunction with FIG. 2, there are illustrated various graphical user interfaces that are used for acquiring information for the system for ordering products and services. Using a registration form 226 as illustrated in FIG. 3, a user is able to enter various information within the client side functionalities 216 to enable their registration with the central office 104. The registration window 302 may include a number of data fields enabling the entry of information. These may include name field 304, user name field 306, address field 308, city field 310, state field 312, zip field 314, an email address field 316, and credit fields 318 enabling the entry of credit card information such as credit card type, card number and expiration date. When this information is entered within the registration window 302 it is encrypted by the encryption functionality 222 to enable the transport of the information over the internet communications link 214. In one embodiment, rather than storing the credit card information from the credit card data fields 318 within the database 106 associated with the central office 104, the information may be stored locally with the client side functionalities 216. One reason for this is better protection of a user's credit card information. This precaution would limit the possibilities of large scale access of credit information from unauthorized third party attacking the database 106 associated with the central office 104.

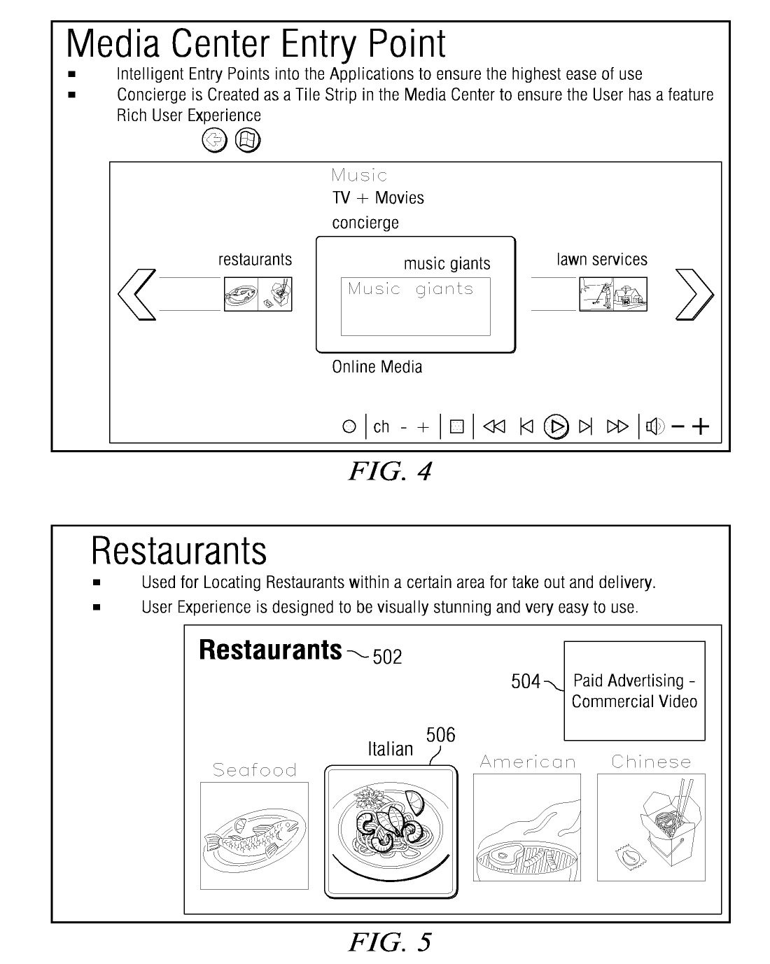

Referring now also to FIG. 4, there is illustrated the graphical user interface entry point to the products and services system. The entry point would provide a number of icons for selecting particular types of goods and services through a display interface on a touch screen or a screen of a television within the user's home that is associated with the home's audio visual network. One section of the graphical user interface would enable the user to access information related to for example, restaurants, lawn services, etc. With respect to the present disclosure, the client side functionalities are provided under the graphical user interface by the name Concierge. Of course, any identifying name could be utilized with the functionalities that provide the ability to access various products and services via the home's audio visual network system. As one would expect, in addition to providing access to the online purchasing of products and services through the home audio visual network, the graphical interface would provide access to the other type of audio visual functionalities available through the home audio visual network such as music, TV, movies, etc.

Through the main entry screen, the user would have the ability to access the restaurant screen 228. One example of a graphical user interface associated with a restaurant screen is illustrated in FIG. 5. This screen includes an indicator 502 describing the type of products or services that are associated with this particular graphical user interface. The graphical user interface may also include advertising area 504 wherein fixed or video based advertising information may be displayed within the advertising area 504. This advertising may be user directed to food and/or restaurant services since the user is already demonstrating an interest in these types of services by accessing the restaurant screen 228. The graphical user interface would also include a number of category selection areas 506. These category selection areas 506 would include different types of food which may be selected by the user to receive a list of restaurants located near the user as will be described more fully hereinbelow. Examples of these include seafood, Italian, American, Chinese, etc.

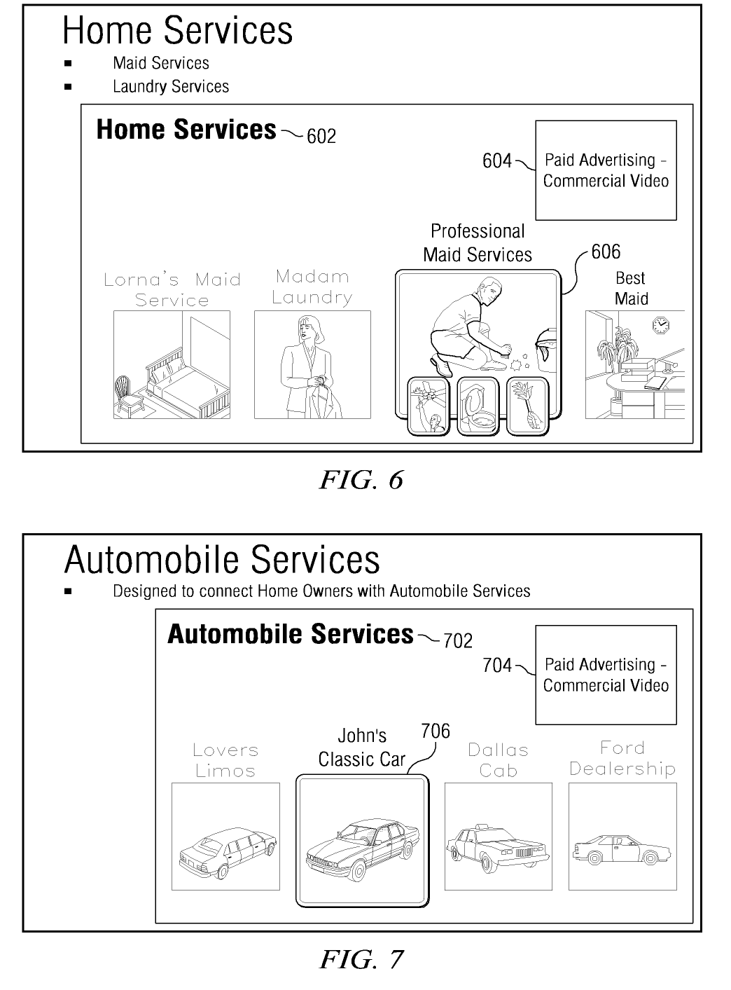

The home services screen 230 provides access to various locally provided home services and products. An example of the graphical user interface comprising the home services screen 230 is illustrated in FIG. 6. Like the restaurant screen 228, the home services screen 230 includes an indicator 602 indicating the services displayed within the screen. Additionally, an advertising field 604 may be used to place static or video advertising related to the provision of home services or any other related service that might be directed to an individual looking at home services. Finally, a number of service selection fields 606 are listed along a portion of the screen indicating various home service entities or groups that may be accessed by the user. Examples of home services that may be used by an individual include maid services, laundry services, home repair services, etc.

The automobile services screen 232 includes a listing of services that the user may need with respect to their car or transportation services. One example of an automobile services screen is illustrated in FIG. 7. The automobile services screen like the previously described screens includes an identifier field 702 indicating the services being provided and an advertising area 704 wherein advertising information directed to the user may be placed. Service provider fields 706 list various services associated with an automobile such as dealerships, cab services, limousines, etc. Clicking on one of these service provider fields 706 will then take a user to an area enabling them to purchase services from these vendors.

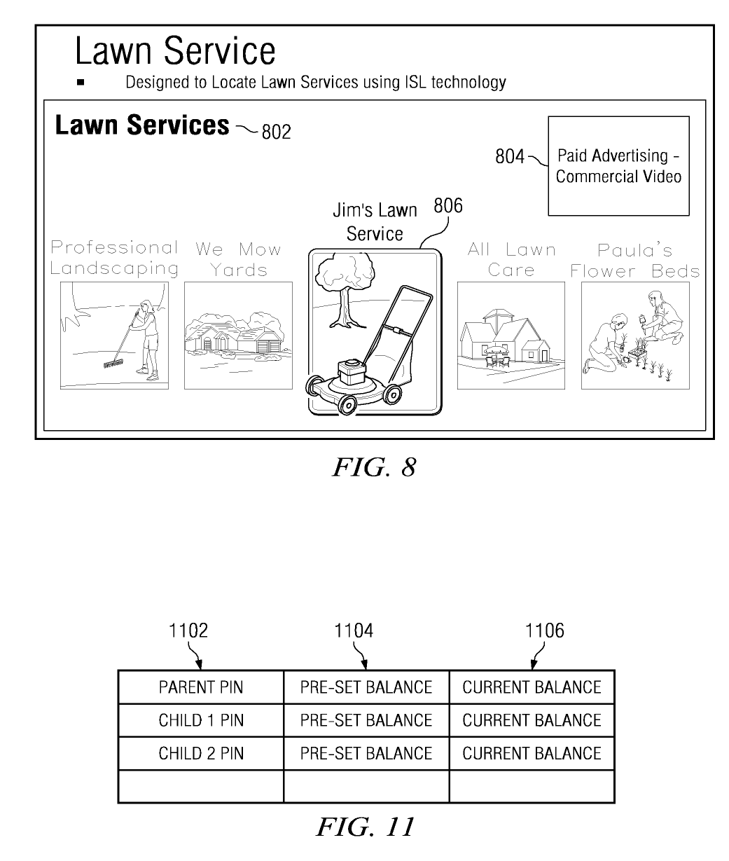

Referring now also to FIG. 8, other examples of services screens include lawn services, which includes indicator 802, advertising area 804 and service fields 806 enabling access to a variety of different types of lawn services. These types of screens can be created for any product or service.

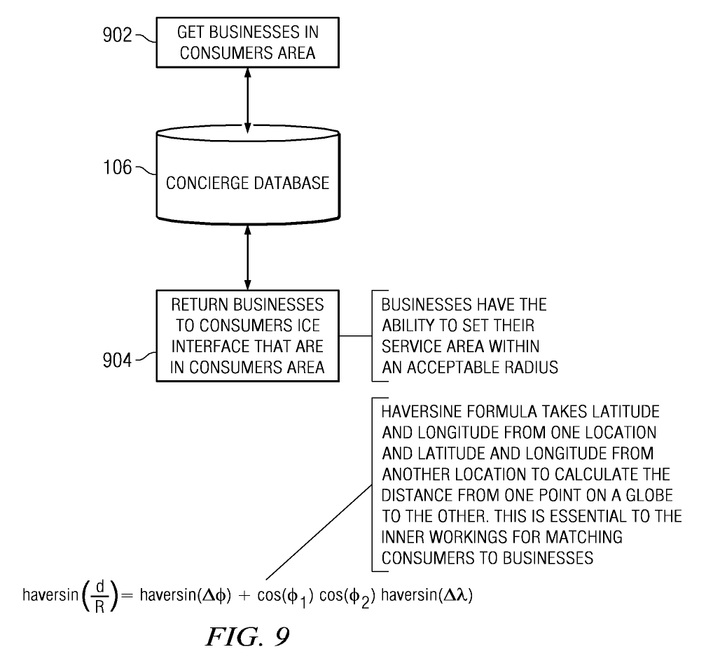

Referring now to FIG. 9, there is illustrated the manner in which information related to various vendors 108 is collected responsive to a request by the user through the client side functionalities 216 for a particular product or service. Responsive to a product or service request, the central office 104 will determine all of the businesses providing the requested services within the user's area 902. This information is obtained from the database 106. The gathered information is then returned from the database 106 to the client side functionalities 216 of the requesting user at 904. The information contained within the database 106 with respect to each of the vendors may have particular service area restrictions associated with the vendor. For example, a particular restaurant providing delivery services of their food may only deliver within a defined area. The information contained within the database 106 would include this information such that the user would not be provided with information to restaurants that did not serve their area. The provided information relating to business may also be based upon calculations of distance between the location of the home controller 102 associated with the requesting user and the location of the vendor as indicated within the database 106. Information for determining the distance may be calculated utilizing the haversine formula described hereinabove which takes the latitude and longitude from one location and the latitude and longitude from another location to calculate the distance between these points on a globe. This calculation assists in matching a consumer to a particular business in their area. However, other distance calculation methods may be used.

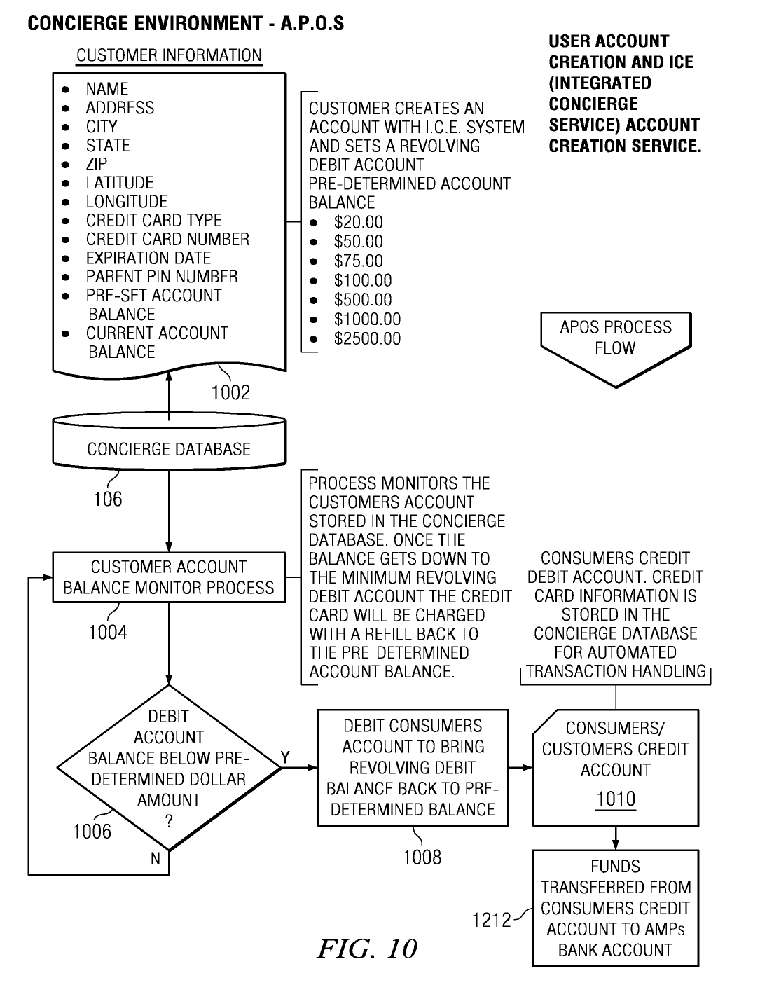

Referring now to FIG. 10, there is illustrated the manner in which a customer may register with the audio visual services based system using the registration form screen 226 described previously with respect to FIG. 2. Initially, at 1002 all of the customer related information is entered into the client side functionalities 216 for storage both locally and within the central office 104 at the central office database 106. The customer information that may be stored includes, but is not limited to, name, address, city, state, zip, latitude, longitude, credit card type, credit card number, expiration date. Additionally, a number of PIN numbers associated with differing members of the family can be wherein each of these PIN numbers has a preset account balance and a current account balance associated therewith.

Referring now also to FIG. 11, there is illustrated the manner in which the information stored within the central office database 106 may be associated with unique PINs within a family. Column 1102 illustrates various family member PINs. The parents may have a PIN which is usable by the mother and father in a family. Additionally, each child can have an associated PIN through which they are able to purchase services and/or products using the system. Associated with each of the PIN numbers in column 1102 are a preset balance indicated in column 1104 and a current balance indicated in column 1106. The preset balance illustrates the amount associated with the PIN that may be charged during a particular time frame or in total. Thus, the preset balance associated with the parent PIN would be a particularly high number as the parents have wide latitude in charging for products and services using the system. The child PINs would likely have substantially lower preset balances since the child would be somewhat limited in the amounts that they could charge for particular products and services. In addition to limiting the total amount that could be charged, the preset balance could be limited by, for example day or week such that a child would be allowed to charge more than they were allowed at a particular period of time or to a vendor or type of vendor. For comparison purposes to the preset balance is the current balance listed in column 1106. The current balance is compared with the preset balance prior to each transaction to enable a determination of whether the transaction should be allowed to go forth. The preset balance established within the column 1104 may be of any increment but will normally be established in five or 10 dollar increments by the account user.

Referring now back to FIG. 10, once all of the customer information has been entered by the customer at the client side functionalities 216, all of the information is encrypted and placed within an XML document that is transmitted to and stored within the central office database 106. The customer account balance monitoring process 1004 monitors the customer's bank account information stored within the database 106 and monitors the preset balances and current balances described with respect to FIG. 11. Once the account balance gets down to the minimum revolving debit account value, charges may be ceased on the associated account or the central office 104 may initiate a new credit card charge to the account that will replenish the account back to a predetermined account balance. Inquiry step 1006 monitors to determine if the debit account balance has fallen below the predetermined amount. If not, control passes back to block 1004 to continue monitoring the account balance. If the debit account balance does fall below the predetermined dollar amount, the consumer's debit account is accessed to bring the revolving debt balance back to the predetermined level at step 1008. After the account balance has been changed, the customer's credit account information within the database 106 is updated at 1010 to reflect the made changes. Responsive to the request, the necessary funds are transferred from the customer's credit account to a bank account of a vendor at step 1212.

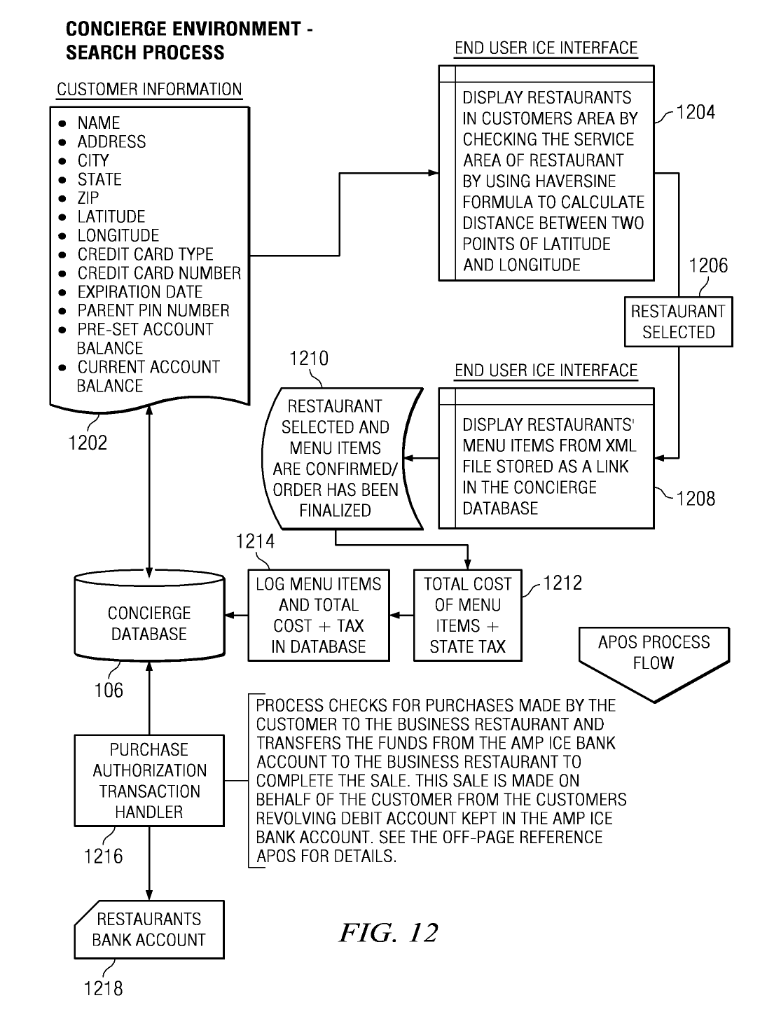

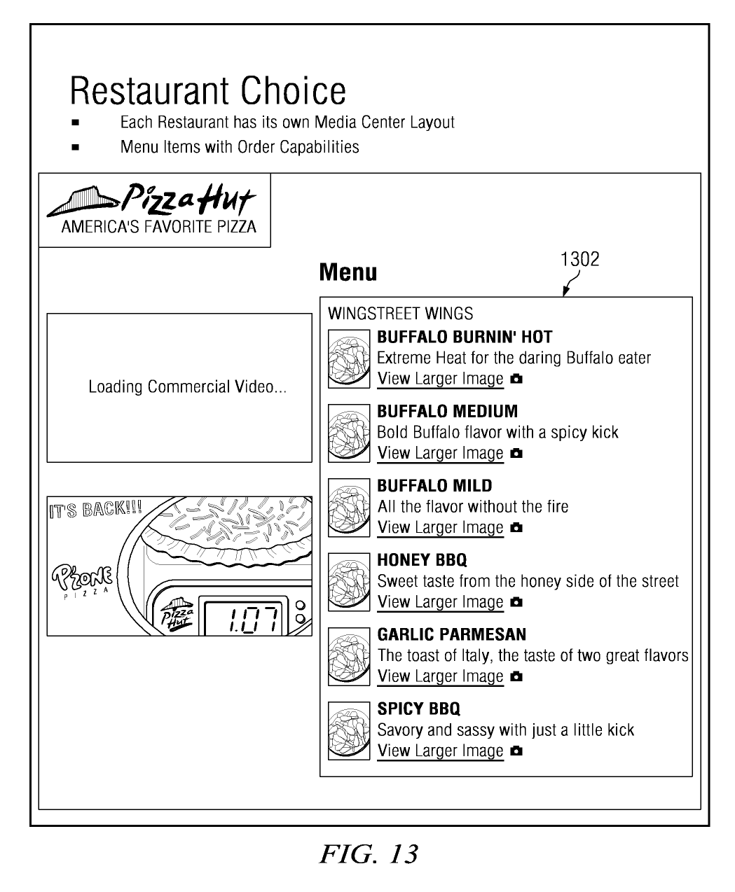

Referring now to FIG. 12, there is more fully illustrated the search process wherein a user may search for a particular service to be provided to the user. In this case, the search is for a restaurant and includes the ability to order food therefrom. The customer information 1202 is used to interact with the graphical user interface of the client side functionalities 216 at 1204. This end user graphical interface displays restaurant in the customer area by determining the service area of the restaurant using the haversine formula to calculate the distance between the user and the various restaurants of a particular type within the area. The client side functionalities receive a selection at 1206 of one of the restaurants for the user, and the client side functionalities 216 utilize the graphical user interface to display a restaurant menu at 1208 from XML files stored as a connection link within the database 106. This menu display appears within a graphical user interface similar to that illustrated in FIG. 13. The illustration in FIG. 13 displays a menu 1302 of the restaurant which may be navigated by the user to select the particular items they wish to order. In addition to displaying the menu 1302, the graphical user interface may display ads 1304 that reference various specials or products that the restaurant wishes to promote. The particular menu items that are desired are confirmed and ordered through the graphical user interface at step 1210. The total cost of the order of menu items is determined at step 1212. The selected menu items are provided back to the database 106 along with the total cost at step 1214. The purchase transaction authorization handler 1216 within the central office 104 will check for purchases made by the customer to the associated vendor and transfer the funds from the customer account to the bank account of the vendor to complete the transaction. The sale is made on behalf of the customer by the central office 104 from the customer's revolving debit account. The transaction is completed upon deposit of the necessary funds within the restaurant's bank account at step 1218.

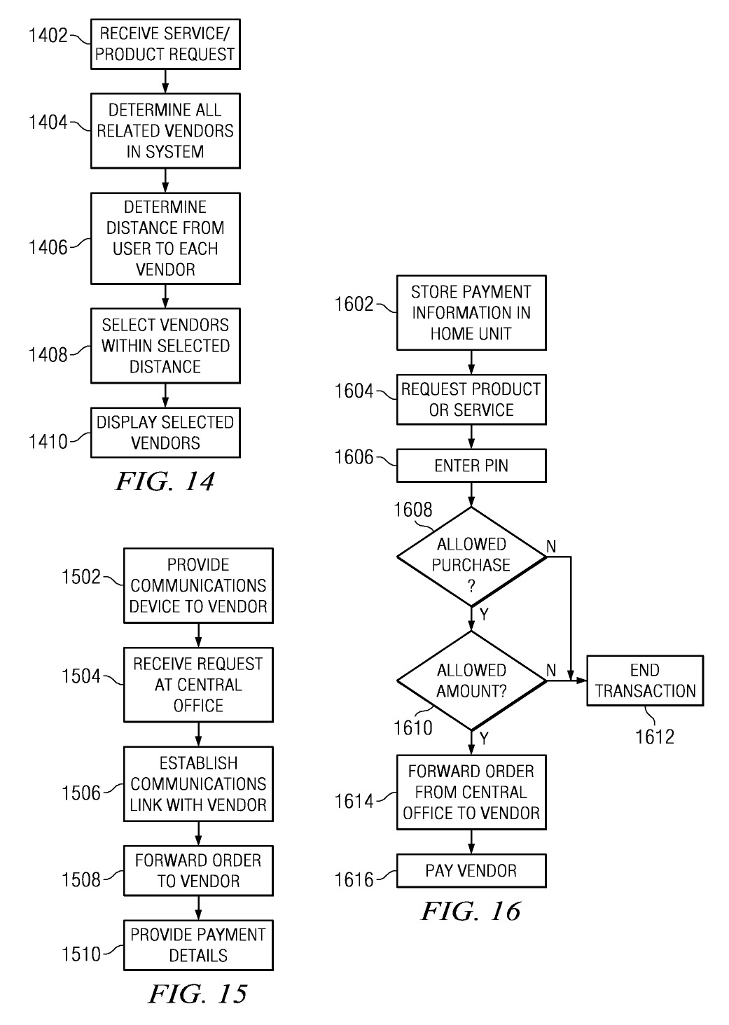

Referring now to FIG. 14, there is illustrated a flow diagram more fully describing the process wherein the user is presented with a group of vendors that are located close enough to provide a desired service or product. Initially, at step 1402, the central office 104 receives a service/product request. The request includes the type of service being requested, lawn service, restaurant, home service, etc., and will also include information indicating a desired distance that the user is willing to come for the service or product requested or alternatively, the service request might require the system to determine the distance that particular services or products will be provided from vendors that may be utilized. The available vendors within the system providing the desired product or service are determined at step 1404. Next, the distance from each of these vendors to the user requesting the service or product is determined at step 1406. This distance determination may be based upon the haversine formula described hereinabove. As mentioned previously, other methods for determining the distance between the vendors and the user's home controller 102 may also be utilized. At step 1408, a determination is made of vendors that are close enough to provide the desired services or products to the requesting user. This may involve a determination that the vendors are within a distance that has been established by the user requesting the service or product or that a vendor service area is close enough to the user requesting the service based upon the determination of the distance between the vendor and the home controller. Finally, each of the vendors that have been selected are displayed to the user at step 1410 such that the user may then make any desired selection.

Next, referring now to FIG. 15, there is a flow diagram more fully illustrating the process by which the central office 104 may order the services or products directly from a vendor. Initially at step 1502, the vendor is provided with some type of communication device to enable communications between the vendor 108 and the central office 104. A communication device may comprise some type of pager or software to run on their cell phone or wireline phone system to enable the receipt of new requests from customers in the area. Next at step 1504, a request is received from the customer that is requesting a particular service of a vendor. The communication link is established either from the central office to the vendor or from the customer to the vendor at step 1506 to enable transmission of an order and payment information. Once the connection has been established, the order may be forwarded to the vendor either from the central office or from the customer at step 1508. Once the order has been transmitted to the vendor, the payment details are also provided to the vendor at step 1510 from either the customer or central office. The vendor may then go to the process of completing the order for the services and/or goods that have been ordered.

Referring now back to FIG. 16, there is illustrated a flow diagram more fully illustrating the process for ordering a product or service via the above described system. Initially, at step 1602, the user will store their payment information through the home unit that is either stored at the home controller 102 or at the central office 104. The user may request through their home controller 102 at step 1604 a product or service using their home audio visual system. Prior to purchasing any product or service the user is required to enter a PIN number at step 1606. Inquiry step 1608 determines based upon the provided PIN number whether this is an allowed purchase. This may be due to the fact that a child PIN number only lets the child purchase from certain limited vendors. If this is an allowed purchase, control passes to inquiry step 1610 wherein the amount of the purchase is examined to determine if it is an allowed amount. If this transaction is determined to not be an allowed purchase at inquiry step 1608 or is determined an allowed amount at step 1610, control passes to step 1612 and the transaction is ended. If inquiry step 1610 indicates this is an allowed amount, the order is forwarded from the central office to the vendor in the manner described with respect to FIG. 13. The vendor may then be paid from the user's account directly to the bank account of the vendor at step 1616.

It will be appreciated by those skilled in the art having the benefit of this disclosure that this home services provision system using home audio visual system provides a system and process for ordering goods and services through a home audio visual system. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A system for providing products and services, comprising:
a client module enabling a user to order the products and services over a connected network, wherein the client module is implemented within a home audio visual system;
a server remotely located from the client module and interconnected with the client module via the connected network;
wherein responsive to a user request for the products and services via the client module, the server determines a plurality of different vendors providing the products and services that are within a predetermined distance from a location of the client module and transmitting data related to the determined plurality of different vendors to the client module over the connected network;
wherein responsive to the received data the client module generates a graphical user interface displaying the plurality of different vendors through the home audio visual system.

2. The system of claim 1, wherein the client module responsive to receipt of a selection of a particular vendor and a particular product or service through the home audio visual system transmits data relating to the selection of the particular vendor and the particular product or service to the server and further wherein the server completes a transaction with the particular vendor for purchase of the particular product or service on behalf of the user.

3. The system of claim 2, wherein the selection of a particular product or service further requires entry of a PIN number to enable the transaction of the particular product or service and further wherein the PIN number is uniquely associated with a particular member of a family using the home audio visual system.

4. The system of claim 3, wherein the PIN number has a predetermined monetary limit associated therewith.

5. The system of claim 1, wherein the server determines the predetermined distance using the haversine formula.

6. The system of claim 1, wherein the server determines the predetermined distance by determining a longitude and latitude of a location of the client module and of a location of the plurality of different vendors.

7. The system of claim 1, wherein the client module is implemented within a Windows Media Center.

8. The system of claim 1, wherein the client module enables the user request by presenting a plurality of graphical user interfaces displaying information relating to the products or services.

9. The system of claim 1, further including a database associated with the server, the database storing information relating to a user associated with the client module and information relating to a plurality of vendors providing the products or services.

10. The system of claim 9, wherein the information relating to the plurality of vendors further comprises at least two of location data, menus, service list.

11. A method for providing products and services, comprising:
ordering products or services through a client module implemented within a home audio visual system;
transmitting the order to a server remotely located from the client module via a connected network;
determining a plurality of different vendors providing the products or services that are within a predetermined distance from a location of the client module at the server;
transmitting data related to the determined plurality of different vendors to the client module over the connected network; and
generating a graphical user interface displaying the plurality of different vendors through the home audio visual system responsive to the received data the client module.

12. The method of claim 11, further including the steps of:
selecting a particular vendor and a particular product or service at the client module;
transmitting data relating to the selection of the particular vendor and the particular product or service to the server responsive to receipt of the particular vendor and the particular product or service through the home audio visual system; and
completes a transaction with the particular vendor for purchase of the particular product or service on behalf of the user from the server.

13. The method of claim 12, wherein the step of selecting further comprises the steps of entering a PIN number uniquely associated with a particular member of a family to enable the transaction of the particular product or service through the home audio visual system.

14. The method of claim 13, further including the step of associating a predetermined monetary limit with the PIN number.

15. The method of claim 11, wherein the step of determining further comprises the step of determining a predetermined difference between the client module and the plurality of different vendors.

16. The method of claim 15, wherein the step of determining the predetermined distance further comprises the step of determining the predetermined distance using the haversine formula.

17. The method of claim 15, wherein the step of determining the predetermined distance further comprises the step of determining a longitude and latitude of a location of the client module and of a location of the plurality of different vendors.

18. The method of claim 11, further including the step of implementing the client module within a Windows Media Center.

19. The method of claim 11, wherein the step of ordering further comprises the step of presenting a plurality of graphical user interfaces displaying information relating to the products or services to a user through the home audio visual system.

20. The method of claim 11 further including the step of storing information relating to a user associated with the client module and information relating to a plurality of vendors providing the products or services within a database associated with the server.

21. The method of claim 20, wherein the information relating to the plurality of vendors further comprises at least two of location data, menus, service list.
